(19) United States
(12) Patent Application Publication
(10) Pub. No.: US 2006/0033617 A1
(43) Pub. Date: Feb. 16, 2006

(54) Perimeter security

(76) Inventor: Glenn Mark Wakefield, Tempe, AZ (US)

Correspondence Address: Glenn Wakefield, 1416 East Carmen Street, Tempe, AZ, 85283-4142, US

(21) Appl. No.: 10/998,293

(22) Filed: Nov. 27, 2004

Related U.S. Application Data
(60) Provisional application No. 60/526,002, filed on Nov. 29, 2003.
(60) Provisional application No. 60/535,280, filed on Jan. 10, 2004.

(51) Int. Cl. G08B 13/00; G08B 19/00; G08B 1/08

(52) U.S. Cl. 340/541; 340/522; 340/539.22

(57) ABSTRACT

A perimeter may be effectively secured by a system of manual/autonomous stationary/mobile units on land/water, by a system of manual/autonomous aircraft/spacecraft and by a system of physical barriers. A wide range of surveillance, communication and scientific equipment will be associated with these systems and they will all be associated with stationary/mobile control centers.

### CROSS-REFERENCE TO RELATED APPLICATIONS

Provisional application No. 60/526,002, filed November 2003.

Provisional application No. 60/535,280, filed January 2004.

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISC APPENDIX

Not Applicable

### BACKGROUND OF THE INVENTION

This patent application applies to the field of security.

Perimeter security revolves around prominent individual technologies (i.e. cameras) applied to securing an area. Many simple variations of this concept have been implemented to provide a greater degree of security.

### BRIEF SUMMARY OF THE INVENTION

A perimeter may be effectively secured by a system of manual/autonomous stationary/mobile units on land/water, by a system of manual/autonomous aircraft/spacecraft and by a system of physical barriers. A wide range of surveillance, communication and scientific equipment will be associated with these systems and they will all be associated with stationary/mobile control centers.

### BRIEF DESCRIPTION OF THE SEVERAL VIEWS OF THE DRAWING

Not Applicable

### DETAILED DESCRIPTION OF THE INVENTION

Place stationary towers (i.e. guy wire, self supporting) or manual/autonomous mobile towers (i.e. telescoping tower mounted on a manual/autonomous truck) an appropriate distance apart along the perimeter that needs securing. The type of tower, the distance between towers and the equipment associated each tower will be a function of location, terrain and cost. All of the appropriate sensors/devices will be associated with each tower ((i.e. an audio detection system, a speaker system, different wavelength camera systems (ultraviolet, visible, infrared), different wavelength lighting systems (visible, infrared), a radar/lidar system, a nonvisible laser beam detection system (alarm on breaking of beam), ground pressure/vibration sensors)). An enclosure may protect appropriate equipment. The system will protect all four ground (on and below) quadrants and all four air/space quadrants. Monitoring the air quadrants will detect normally unnoticed low flying aircraft crossing the security perimeter. Power each tower by an appropriate energy system ((i.e. by the power grid with an independent power source backup (fuel cell backup) or by two non grid power sources one acting as the backup of the other (solar panel and fuel cell backup))). Stations may perform scans under automated software control or under manual control. Each station may monitor itself and its neighbors in regard to tampering and theft. Transmit sensor information, self diagnostic data and other appropriate data to stationary or mobile control centers.

Protection may be afforded to water as well as land perimeters. Securing the water perimeter may be accomplished by a series of fixed or mobile units (i.e. towers, buoys, craft) that are an appropriate distance apart. All of the appropriate sensors/devices will be associated with each unit (i.e. sonar, hydrophones, magnetic sensors, water penetrating electromagnetic waves, all of the items listed above). The units may be attached to the floor of the body of water by a stabilizing mechanism capable of handling the prevailing conditions. The system will protect all four water (on and below) and all four air/space quadrants. In addition to perimeter security, the border monitoring stations may be used for communication, weather, environment and scientific purposes. For example along the structure connecting the unit to the floor of the body of water may be sensors/instruments for determination of temperature/chemical composition of the water, pollution level monitoring and camera/sonar for viewing underwater life/fish counting. Special scientific equipment may also be placed within the units. The land monitoring stations may be used similarly for scientific purposes.

Protection of the land/water border (with associated air/space above) and/or a section of air/space may be accomplished through the use of manual/automated aircraft/spacecraft (i.e. fixed wing, rotary wing, airship, satellite, spaceship). All of the appropriate sensors/devices could be designed into the aircraft/spacecraft to secure the perimeter (i.e. all of the items listed above). Scientific equipment may be placed on the aircraft/spacecraft. Different size and capability aircraft/spacecraft may be in the group to handle different situations. An actual physical barrier (i.e. a single fence/wall, a double fence/wall with a no man's zone between or an appropriate fence/wall system) may be constructed in association with the land, water, air and/or space. The physical barrier may have appropriate sensors/devices/instruments. The land towers, water units, aircraft/spacecraft and physical barrier may be powered by an appropriate energy source; have appropriate sensors/devices/instruments; perform manual/programmable scans on/above/below the water/land and a section of air/space; perform self diagnostics/repair; communicate with stationary/mobile control centers or directly with other systems; and secure the perimeter independently or in combination with the other systems. This would effectively seal the perimeter and provide valuable scientific information.

I claim:

1.) A perimeter may be effectively secured by a system of manual/autonomous stationary/mobile units on land/water, by a system of manual/autonomous aircraft/spacecraft and by a system of physical barriers.

2.) Referring to claim 1, the systems for securing the border may be applied independently or in combination with the others systems.

3.) Referring to claim 1, the system may monitor on/above/below the land/water and a section of air/space.

4.) Referring to claim 1, the system may communicate directly with other systems or with stationary/mobile control centers.

5.) Referring to claim 1, the system may be powered by an appropriate energy source.

6.) Referring to claim 1, each system may be able to perform programmable scans, manual scans and self diagnostics/repair.

7.) Referring to claim 1, sensor assemblies, communication equipment and other instruments may be associated with each system ((i.e. an audio detection system, a speaker system, different wavelength camera systems (i.e. ultraviolet, visible, infrared), different wavelength lighting systems (i.e. visible, infrared), a radar/lidar system, a laser beam detection system (alarm on breaking of beam), a ground pressure/vibration sensor system, a hydrophone system, a sonar system, a magnetic sensor system)).

8.) Referring to claim 1, research equipment may be associated with each system (i.e. sensors or instruments for determination of weather parameters, temperature/chemical composition of the water/atmosphere, pollution level monitoring of the water/atmosphere and cameras/sonar for viewing or counting underwater/land/air life).
